(19) United States
(12) Patent Application Publication
(10) Pub. No.: US 2017/0228688 A1
(43) Pub. Date: Aug. 10, 2017

(54) SYSTEM AND METHOD FOR STRATEGIC RFID TAG READING USING PHYSICALLY DISPERSED BARCODES AND SUPPLEMENTAL AUTOMATED INVENTORY MANAGEMENT THROUGH MOBILE RFID READERS

(71) Applicant: Tri-8, Inc., Stillwater, OK (US)

(72) Inventor: Jarrod Bourlon, Centerton, AR (US)

(73) Assignee: Tri-8, Inc., Stillwater, OK (US)

(21) Appl. No.: 15/428,883

(22) Filed: Feb. 9, 2017

Related U.S. Application Data
(60) Provisional application No. 62/293,411, filed on Feb. 10, 2016.
(60) Provisional application No. 62/328,763, filed on Apr. 28, 2016.

(51) Int. Cl. G06Q 10/08; G06K 7/10; G06K 19/077

(52) U.S. Cl. CPC G06Q 10/087; G06K 19/07758; G06K 7/10366

(57) ABSTRACT

A strategic inventory collection and management systems and methods using mobile radio frequency identification (RFID) readers for collecting inventory data and providing users with real time feedback and inventory instructions for more accurate and efficient inventory data collection and supplementing or augmenting automated inventory management (AIM) system data.

This application claims priority to pending U.S. Provisional Patent Application No. 62/293,411 filed Feb. 10, 2016 and to pending U.S. Provisional Patent Application No. 62/328,763 filed Apr. 28, 2016, both incorporated herein in their entirety by reference.

### BACKGROUND OF THE INVENTION

Technical Field

The present invention relates to systems and methods for achieving more accurate inventorying of items by providing user instructions based on prior inventory data collected by a mobile radio frequency identification (RFID) reader to direct a more refined area of inventorying and supplementing or augmenting automated inventory management (AIM) system data.

Description of Related Art

For many manufacturers, retailers and distributors, management and effective control of inventory of goods or supplies is critical. Handheld RFID solutions are driven by humans, and thus are subject to error or subjective inefficiencies. RFID technology presents a solution, allowing items to be inventoried to be “tagged” with an item that may be sensed by an RFID reader. RFID handheld readers can sense a tagged item if the reader is placed in relatively close proximity to the item. Because humans must execute the process of “sweeping” around the inventory area to read RFID tags, the process is notoriously ineffective. Even employees who intend to do a good job often are unable to achieve good coverage on their own. Furthermore, location information (where the RFID tag is) is difficult to ascertain even when the tag is successfully read. Thus, current handheld RFID solutions are not as effective as necessary for accurate inventory scanning (RFID tag reading). Accordingly, there is a need for a more foolproof way to drive a process via software that will guide the human.

Some mobile RFID tag reader implementations employ beeping indicators to direct the user when an audit is complete. The mobile reader may beep once for each unique tag read. This has been coined as the “popcorn effect” in that when there is a certain amount of time in between beeps or “pops”, then the sense is that the scanning is near completion.

A problem with this approach is that it does not ensure a good audit in terms of RF coverage. A user who scans in a single location will eventually realize this “popcorn effect” when in actuality the user has not scanned to the degree necessary to achieve an adequate amount of coverage.

One solution for effective control of inventory of goods or supplies is the automated inventory management (AIM) system. AIM systems have been employed often in large-scale, high volume enterprises. Typical AIM systems include a series of stationary RFID readers, located at an elevated location, such as on the ceiling of a warehouse or retail outlet. Handheld RFID readers used by humans are subject to operator error or subjective influences. Stationary readers, on the other hand, do not rely on an operator, but exploit movement of items bearing an RFID tag located within the range of the reader. The utilization of movement of an item bearing an RFID tag to and from zones covered by the stationary tag reader of the AIM system (typically up to 50 meters) allows for accounting at a central processing location for that particular item. In addition, AIM systems can detect patterns that associate the exit of an item from a zone of coverage with the purchase of the item and its exit from the store or warehouse. As a result, the enterprise's inventory records are updated accordingly.

A limitation on AIM systems is the inability to read tagged items that are placed in areas with limited or no RF coverage, such as within metal shelves or bins. These items may avoid detection by the source RFID reader and other stationary readers for a variety of reasons, including electromagnetic interference within an AIM reader's coverage zone that prevents the ability to sense an item incorrectly shelved by a person among other items. Also, even if an item is moved, interference with the reader (electromagnetic or otherwise) may cause the reader not to sense a particular tagged item that has been moved. Over time, the AIM system may conclude that the item has left the facility, when in fact it has not. There is a need in the art, therefore, for a system to supplement the movement data of the AIM system to correct or confirm information about an item's position.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a network diagram of the present RFID tag reading system according to an embodiment of the present invention.

FIG. 2 is a diagram of a handheld RFID reader according to an embodiment of the present invention.

FIG. 3A is a representation of a path of a handheld RFID reader applied during inventory data collection by a user.

FIG. 3B is a representation of an audit result according to a path of a handheld RFID reader applied during inventory collection by a user.

FIG. 4A is a representation of a path of a handheld RFID reader applied during inventory data collection by a user according to an embodiment of the present invention.

FIG. 4B is a representation of an audit result according to a path of a handheld RFID reader applied during inventory collection by a user according to an embodiment of the present invention.

FIG. 5 is a diagram of a series of RF scan fields according to an embodiment of the present invention.

FIG. 6 is a diagram of coverage zones of RF scans according to an embodiment of the present invention.

FIG. 7 is a diagram of coverage zones of RF scans according to an embodiment of the present invention.

FIG. 8A is a flow diagram of a process performed according to an embodiment of the present invention.

FIG. 8B is a depiction of data associated with inventory information collected according to an embodiment of the present invention.

FIG. 8C is a depiction of data associated with a data accumulation process according to an embodiment of the present invention.

FIG. 8D is a depiction of data associated with a data grouping process accordingly to an embodiment of the present invention.

FIG. 9 is a network diagram of the present system for automated inventory management system augmentation according to an embodiment of the present invention.

FIG. 10 is a flow diagram of a process performed according to an embodiment of the present system for automated inventory management augmentation.

FIG. 11 is a representation of processed inventory data according to a process performed according to an embodiment of the present system for automated inventory management system augmentation.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

In the present system for strategic RFID tag reads, Known Touchpoints (“KTs”) are used to guide a user taking inventory with a handheld RFID reader and guarantee location information. KTs are locations or other fixed items that the handheld unit can acquire, scan or register. In one embodiment, KTs can be universal product codes (UPC) or barcodes affixed to shelving modules and other fixed infrastructure units within a retail store. KTs can also be the UPC barcodes affixed to individual products (such as a package of socks). A user engaged in inventory evaluation is sent a stream of instructions visible by the user interface display screen of the handheld unit. The user is instructed in clear, simple language to scan a particular barcode (such as the shelf/modular barcode or barcode on an item). The user can be instructed to scan a single barcode multiple times to confirm compliance or scan various barcodes in a vicinity of interest. This scan event granularly identifies, with high accuracy, the physical position in three-dimensional space of the handheld reader, because the shelf/item location is known. Note that in one embodiment the handheld reader is equipped with both an RFID reader and barcode scanner.

One objective of the described system is to force the operator of the handheld unit to physically place the unit in a particular location to ensure that RFID tagged items in the vicinity will be read. Accordingly, if a particular retail display unit includes a plurality of items that must be counted, the operator can be required to scan the barcode of an inventory item located at an otherwise inconveniently placed location, such as a bottom shelf. The barcode scan of the rather out-of-the-way barcode can be required in order to move forward in the process. That is, an employee equipped with a unit will not be able to record inventoried items until the particular KT barcode is scanned. In one embodiment, the KT can be the UPC of an inconveniently located item of inventory located at an outer region of a shelving unit or fixture. It is contemplated according to one embodiment that it is an item that a consumer eventually brings to the point-of-sale checkout location (i.e., a pair of jeans) that will serve as the KT for the process of inventorying that item. As will be discussed, the dynamic correlation of physical products (barcodes) identified with Electronic Product Code (EPC) tag sets results in a logical two-dimensional coverage plane by the handheld operator. The physical scanning of an item's barcode also causes physical movement of the item, resulting in RF diversity that in turn heightens the probability of tags being read.

Parties interested in accurate inventories can pre-define KT barcode scanning that must occur prior to the inventory taking place. The handheld operator can be further instructed to scan specific products in such a way as to cause the human operator to pass his arms (and therefore, the RFID reader) through wide ranges of motion: UPC barcodes “up high, down low, this side, that side,” and so forth. The UPC barcodes can be dispersed in a way that strategically covers the desired read area. Subsequent operations by the handheld user can be conditioned upon completion of a prior scan in order to move on. This makes the user akin to “a robot” in one sense, scanning each tag in sequence as instructed. The wide, strategic physical pattern causes the RFID reader, which is reading the entire time, to consume many reads.

In order to ensure that a user is covering an adequate amount of physical space, and that the handheld reader is placed in the correct locations, in one embodiment barcode scans serve as an audit waypoint. This waypoint guides the user through the audit process and ensures a proper audit is performed. Correlating barcode scans with the RFID reads and performing set differences of the various data sets can provide a better indicator to the user of whether the RFID transceiver traveled an adequate distance over time.

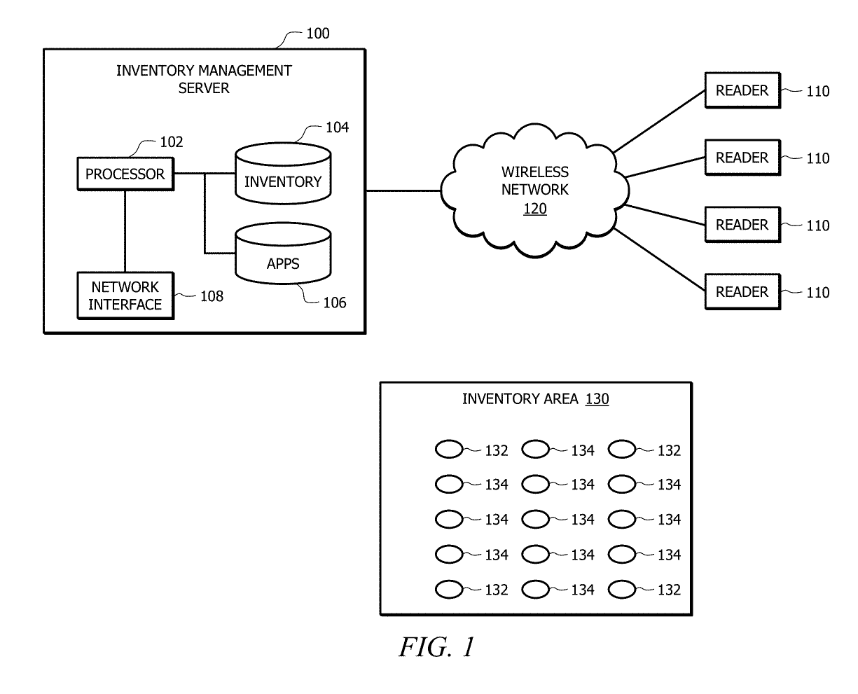

FIG. 1 is a network diagram of the present RFID tag reading system according to an embodiment of the present invention. The system includes inventory management server 100 that includes a processor 102 and associated storage device 104 on which inventory data is stored and storage device 106 on which software applications are stored. Inventory management servers also includes a network interface 108 through which server 100 can communicate with other system devices through a variety of network protocols. Storage device 104 on which inventory data is stored can include KT barcode location data as well as identification data. Storage device 104 can also include results of inventories received from one or more handheld readers 110. Storage device 106 can include application programs delivered to a particular handheld reader 110 according to a location at which a user of that handheld reader is taking inventory. That is, a single barcode or RFID scan can invoke a particular set of scanning and sweeping operations, as will be discussed.

Handheld devices 110 can offer a range of functionality. In one embodiment, handheld device 110 can include components that allow the device to read a UPC barcode and sense an RFID tag. With a device such as this, the user can simultaneously achieve a very broad, very accurate, strategic coverage area for reading RFID tags through scanning of selective UPC barcodes located on the article to be inventoried. As a result, a comprehensive, accurate, location-oriented RFID reading operation is performed by a handheld RFID reader operated by even a minimally skilled or trained human. Handheld device 110 also includes a processor and storage on which various application programs can be stored. Handheld device 110 can include sufficient processing and storage capability to execute the methods and processors described herein that can be performed at inventory management server 100.

Inventory management server 100 communicates with a plurality of handheld readers 110 over a wireless network 120. One or several intermediary devices between handheld readers 110 and server 100 can be in place to facilitate communication between the endpoint devices. Inventory management server 100 and handheld devices 110 can communicate over wireless network 120 according to a variety of protocols, such as cellular, WiFi, Internet Protocol and the like.

FIG. 1 further shows an example of an inventory area 130 of interest. In one embodiment, inventory area 130 includes multiple Known Touchpoints 132 that can be labelled with UPC barcodes, the scan of which forces the operator to come into close range of various items to be inventoried 134 that are tagged with RFID tags. Forcing the user to scan the barcodes associated with inventory items residing at a particular location results in these items serving as KTs 132 (such as the UPC barcode on a pair of jeans). When the user scans the items designated as KTs 132, the user physically passes the reader 110 in close range to a plurality of items 134, causing the items to be sensed by reader 110 and ultimately inventoried. The combination of various inventory items bearing barcodes that serve as KTs 132 based on the location of those items and other items including RFID tags 134 promotes more complete, efficient and accurate inventorying. The placement and quantity of items serving as KTs 132 and tagged items 134 will depend on a variety of factors including the dimensions of the area containing the products to be inventoried and the quantity and/or density of products to be inventoried.

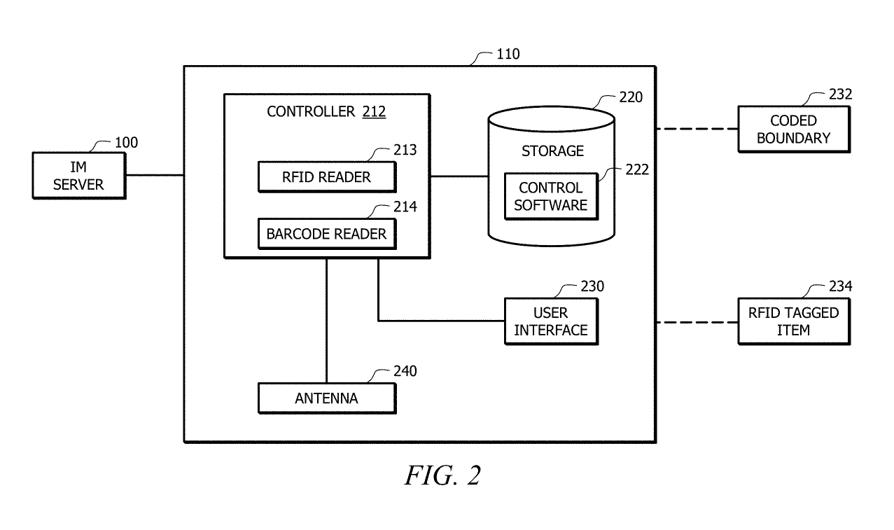

FIG. 2 is a diagram of various components of handheld reader 110 according to an embodiment of the invention. Reader 110 includes a controller 212 that controls operation of RFID reader components 213 and barcode reader components 214. Associated with controller 212 is storage device 220 on which is stored controller software 222 associated with RFID reader components 213 and barcode reader components 214. Handheld reader 110 also includes a user interface 230 that includes a display screen for the user to perceive instructions for operation as well as various keys for entry of data or messages for transmission to inventory management server 100. Handheld reader includes an antenna 240 for receiving signals from RFID tags affixed to tagged items 234 to be inventoried. Barcode reader components 214 include a laser under control of controller 120 to read coded boundary items 232.

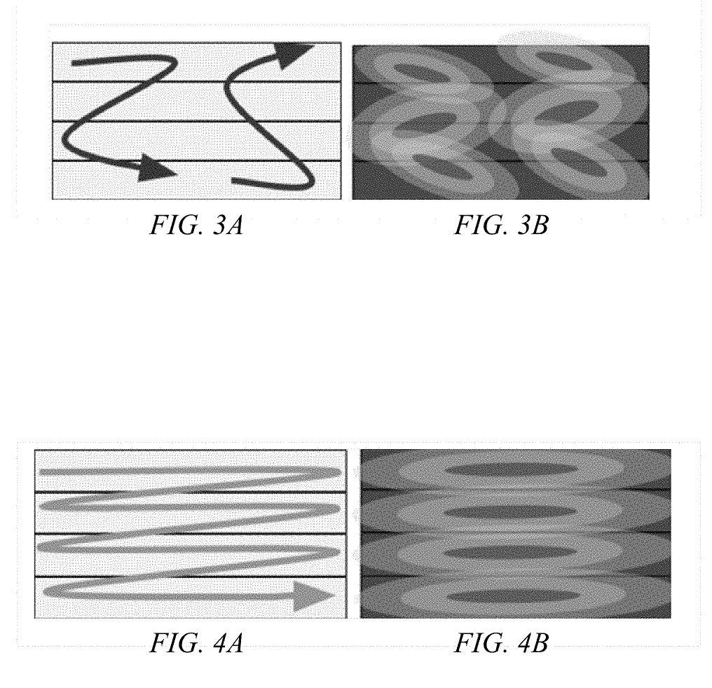

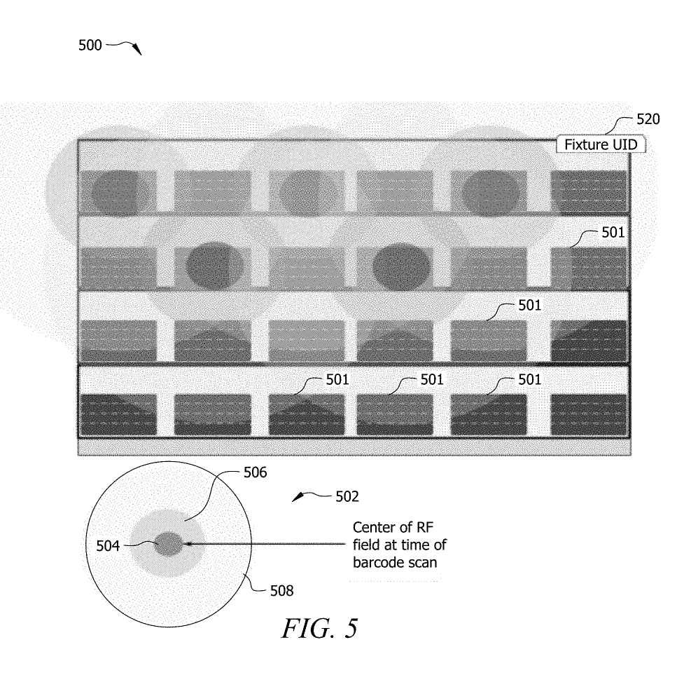

FIGS. 3A and 3B provide graphical representations of a “bad audit” typically resulting from traditional inventorying scanning methods. FIGS. 4A and 4B, on the other hand, depict a “good audit” resulting from the use of the systems and methods of the present invention. In FIGS. 3A and 4A the path taken by the user in passing handheld reader 110 over an area of inventory items is shown. With respect to the “bad audit”, it can be seen that a relatively random path in FIG. 3A of passing handheld device 110 over an area results in a heightened number of gaps in scanning coverage, depicted by the darker shaded areas between the ellipses of FIG. 3B. On the other hand, FIGS. 4A and 4B depict the “good audit” results from the system and methods of the present invention. A systematic and concise path for passage of handheld device 110 as shown in FIG. 4A is performed according to instructions provided to the user. That is, the user is directed to scan barcodes at specific locations that effectively forces the user to pass the handheld reader 110 at certain locations that will make sensing of RFID tagged items more likely. As shown, in FIG. 4B, the resulting read produces smaller gaps in coverage as depicted by the minimal darker shaded areas between the ellipses, especially as compared to FIG. 3B.

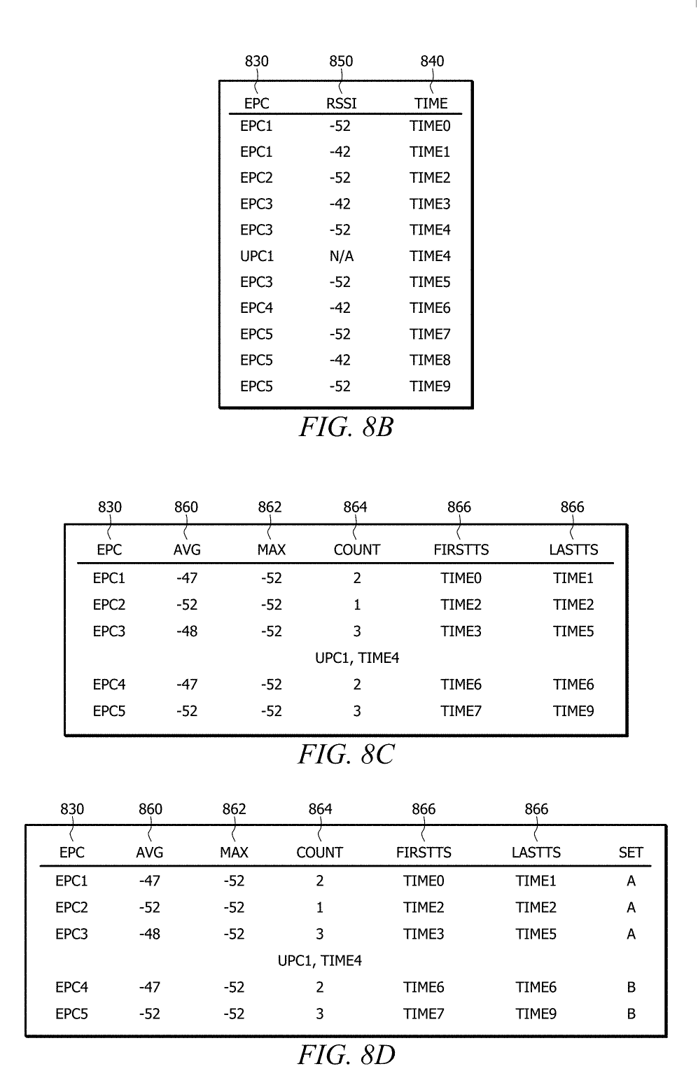

The method of an embodiment of the present invention can be described according to the flowchart of FIG. 8A. The methods and processes described herein can be performed through execution of machine readable instructions by a processor located remotely from the user of the handheld device in the inventory management server. In the alternative, the handheld device can include sufficient processing capability and have stored within a storage medium of the handheld device application programs for executing these methods and processes, with communication of resulting data transmitted to a remote processor and instructions to the handheld user for subsequent product identifier scans (as will be discussed) determined at and presented to the user of the handheld device. The present invention is not limited in terms of the location of the generation of data sets, graphical representations and processing of RFID tag read coverage or generation of instructions for the user of subsequent product identifier scans. Such software for processing the RFID tag read data can in whole or in part can reside within the handheld device itself with all or some of the processing occurring within the device.

The process of FIG. 8A provides a user of an embodiment of the inventory system real-time feedback according to the accuracy and sufficiency of the manner of taking inventory. The process of FIG. 8A begins at step 802 in which the user in instructed to activate the handheld device. At step 804, the user of the handheld device is directed to scan a code on a target fixture. This scan can occur through scan of a barcode on a product fixture having a unique fixture identification number (UID). The UID can represent a subset of a larger inventory space and can be attributable to a particular type of item located in that fixture, such as men's jeans. In the alternative, one item bearing a UPC code can be located at a logical starting point of the inventory process.

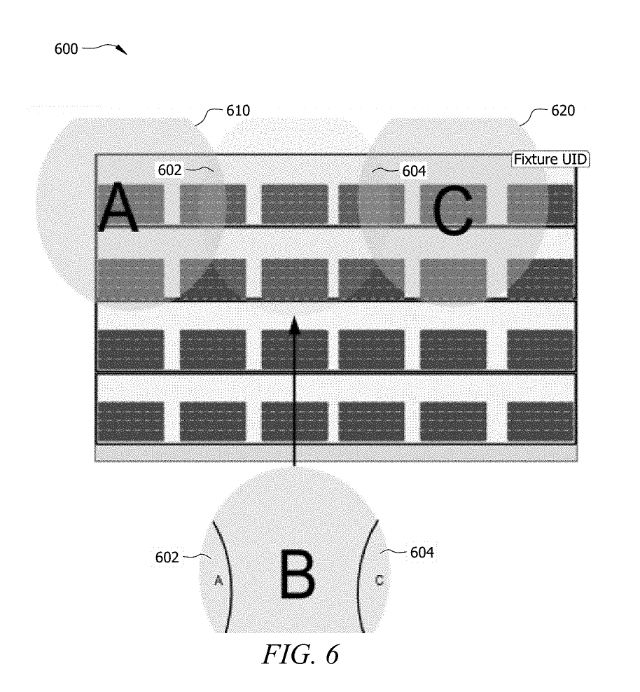

At step 806, the user scans an item to be inventoried at a particular location bearing, for example, a UPC label that serves as a KT barcode. An example of the progression of scanning barcodes is depicted in FIG. 5. In FIG. 5, a retail fixture 500 that can contain various items to be inventoried is shown. The fixture san include a UID 520. Within fixture 500 are a plurality of bays 501 that each can contain similar or different items. Each item within a bay typically includes a UPC code. For articles of clothing, for example, the UPC code can include a series of numbers that identify an article of clothing by brand, type, style, color, size, etc. The article can also include a RFID tag through which this UPC code is associated. Thus, with the handheld device previously described, a user can scan various inventory items bearing the RFID tag.

In FIG. 5, RFID tags affixed to inventory items within field 502 are scanned by a barcode scanner when a scan occurs at a central point 504. A scan occurring at central point 504 will produce a high percentage of reads of RFID tags residing on articles within the central point zone 504. A typical RFID scanner such as handheld reader 110 can scan between 100-200 RFID tags per second. A lesser percentage of RFID tags for items residing within intermediate zone 506 will also be read through a scan at central point 504. An even lesser percentage of RFID tags within outer zone 508 will be read by a scan at central point 504. As shown within fixture 500, a pattern of scans at various locations within fixture 500 will result in a high degree of coverage of items within a fixture. Scans at strategically located central points 504 will result in some overlap of intermediate zones 506 and to a degree outer zones 508. This results in a second scan at a second central point 504 capturing RFID tags residing within a central, intermediate or outer zone of a first scan. This redundancy decreases the likelihood that tagged items will go unscanned. Subsequent scans of fixture 500 as shown in FIG. 5 results in a pattern of overlapping intermediate zones 506 and outer zones 508 to achieve readings of virtually all of the RFID tagged items within fixture 500.

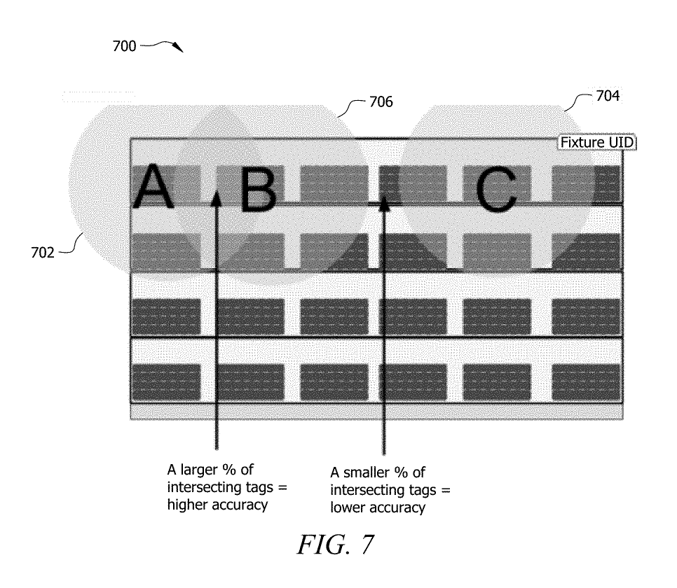

FIG. 6 is a representation of the overlap in scan coverage as discussed with reference to FIG. 5. In FIG. 6, three scans A, B, and C are performed at particular locations within a fixture 600. When a scan order of A, C and B occurs, scans A and C can result in no overlap in the reading of tagged items. Once scan B is made at a location between the central points of scans A and C, a first overlap area 602 of scan zone A 610 and a second overlap area 604 of scan zone C 620 provide a level of redundancy to ensure reads or captures of items situated at the outer limits of scan zone A 610 and scan zone C 620. Subsequent reads similar to those depicted in FIG. 5 will result in greater overlap areas and, in turn, greater coverage.

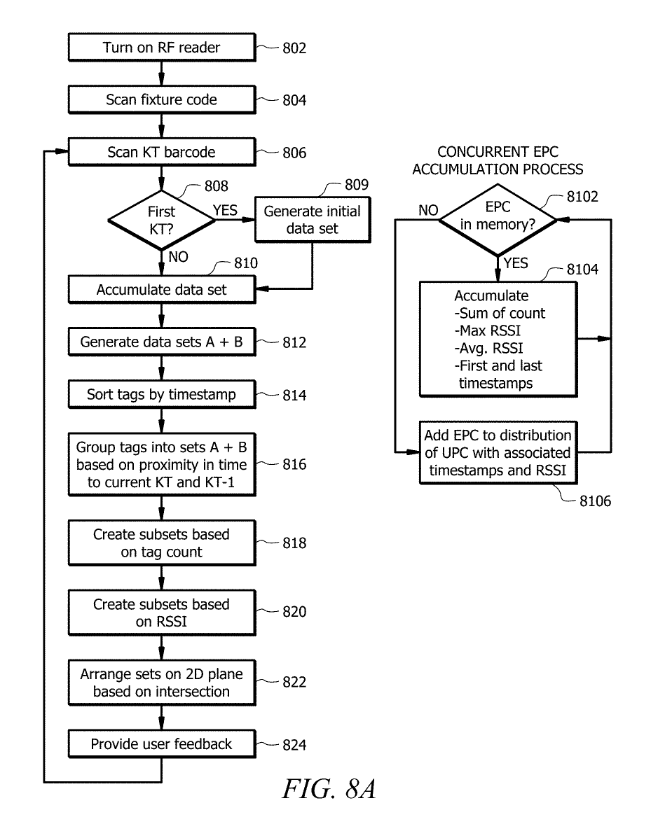

FIG. 7 depicts a scenario where less than optimal coverage results when a third scan B taken after scans A and C is performed at a location where there is no overlap area between scan zone C 704 and scan zone B 706. A scan in this manner results from operator error in terms of inaccurate recollection of the physical location of the scans. In the example of FIG. 7, a fourth scan in the gap between scan zone B 706 and scan zone C 704 will result in a higher degree of coverage. A fourth scan, however, is time consuming and wastes resources. The patterned scan of FIG. 6 is more efficient and promotes further coverage.

Returning to FIG. 8A, once a UPC is scanned as a KT, at step 808 the system queries whether this is the first KT scanned. If this scan is the first KT scan, then a prior data set should not exist. A data set associated with the UID signifying the subset of the total inventory space can exist if a previous scan of UPC codes (acting as KTs) on products within the designated area has occurred. Thus, if the answer at step 808 is yes, then at step 809 an initial data set is generated. In one embodiment, such a data set can be created as described below with reference to the tables in FIG. 8B-8D for Pre-Accumulation and Post-Accumulation Processes.

In FIG. 8B, data associated with a Pre-Accumulation process is provided. As the user begins the process of initiating an inventory session by preparing to scan the UPC code of an inventory item found at a particular location that will serve as a KT, the user's handheld reader will begin scanning RFID tags of various tagged items. Each item's RFID tag identifier is represented in FIG. 8B by an EPC designator 830 EPC1, EPC2, EPC3, etc. Also shown in FIG. 8B is a time stamp 840 and received signal strength indicator (RSSI) value 850 corresponding to information for each RFID tag that has been received. Since the handheld reader begins sensing RFID tags prior to the user scanning the UPC code that serves as the KT, there are reads shown for tagged items with time stamps 840 (times t<4) that precede the time stamp (t=4) of the time at which the first item serving as the KT (the UPC code) was scanned. There is also a RSSI value 850 associated with each RFID read. This pre-accumulation data is stored in an associated database and then accumulated at step 810 for data set creation.

If, on the other hand, the answer to the query at step 808 is no, meaning a data set exists, the process skips to step 810 and data is accumulated. Once the initial data set is generated, the initial data is accumulated as reflected in FIG. 8C.

In FIG. 8C, the individual RFID tag reads are accumulated according to the frequency of reads of an individual item. As shown in FIG. 8B, EPC2 was read once at time t=2, and EPC3 was read three times at t=3, 4, 5. EPC4 was read once at time t=6 and EPCS was read three times at times t=7, 8, 9. In FIG. 8C, the RSSI for each read is averaged on a per item basis and the time range for the readings is noted. As shown in FIG. 8C, for EPC1 the average RSSI value 860 is −47 and the maximum value 862 is −52. The count 864, meaning the number of times that EPC1 was read, is two and the time range 866 for EPC1 was between t=0 and t=1.

In parallel or concurrently with steps 802 through 824, RF transponder replies are processed according to a method of an embodiment of the present invention. The process of accumulating the data is shown in the concurrent EPC accumulation process depicted in FIG. 8A. The accumulation process starts at step 8102 in which it is queried whether a read EPC is already stored in memory. If the answer is yes, then at step 8104 data associated with the EPC, such as count (frequency of reads), maximum and average RSSI and the first (oldest) and last (most recent) timestamps for the reads of the EPC is accumulated with existing values for that EPC. If, on the other hand, the EPC is a new (not previously read) EPC, then the process skips to step 8106 and the new EPC is added to the distribution of UPCs with associated timestamp and RSSI data. The process then returns to step 8102 and existing EPC values are updated/accumulated based on additional reads of a particular EPC or added to the distribution.

Once an initial data set is established and accumulated, the process continues with step 812 for generation of data sets A and B. These data set reflect readings from a previous scan associated with the UID, and include UPC information as well as a received signal strength indicator (RSSI) associated with the particular RFID tag read and a time stamp. The EPC reads will be categorized in groups depending on the timestamps associated with the read and the relationship of the read timestamp to the current KT read and prior KT read. Specifically, at step 814, the accumulated data is sorted according to the timestamp of each EPC read. Next, at step 816 the EPC reads are grouped into separate sets (A and B) based on each read's proximity to the timestamp of a current KT scan and that of a prior KT scan (KT-1). In one embodiment, the EPC reads occurring before the current KT scan, but after the prior KT scan (KT-1) will be grouped in set A and those EPC reads occurring after the current KT scan will be grouped in set B. That is, tag reads occurring between successive KT scans are assigned to a first group A, and reads occurring after the time of the first KT scan are assigned to a second group B, with various averages, counts and first and last time stamps presented as shown in FIG. 8D. FIG. 8D depicts an example of the post accumulation groupings. As seen, the data shown in the table of FIG. 8D includes EPC designator 830, RSSI average value 860, RSSI maximum value 862, count value 864, time range 866 and the assigned set 870. The contents of set B can increase with additional reads occurring from a third KT scan.

Upon the scanning of a second KT UPC code of an item, this data set creation process repeats with the second UPC scan denoted “UPC2” at a time of, for example, t=10. In this second phase, the pre-UPC1 readings (EPC1, EPC2, EPC3 readings are supplanted by the readings between the time stamps of UPC1 and UPC2 (EPC4, EPC5) and sorted and averaged accordingly. The RFID reads occurring in connection with the UPC2 scan are assumed to include additional scans of EPC4 and EPC5 due to the assumed spatial proximity to UPC2 and new readings EPC6, EPC7, etc. The previously read items (EPC4, EPC5) are then sorted and averaged. New data sets such as those depicted in FIG. 8C and FIG. 8D are created for the second KT (UPC2). With each successive KT scan (UPC3, UPC4, etc.), new data sets are created in similar fashion. The result of these steps is the dynamic creation of data sets as the user flows through the scan process of a group of inventory items.

Following these regroupings and sorting operations, at steps 818 and 820, subsets are created based on a ranking of tag reads. A first subset of tag reads in 95 percent of scans, that is, the top 5 percent of the magnitude of each tag read based on the average RSSI value, maximum RSSI value and tag count, is created. A second subset of tags read in 85 percent of scans is created, as represented by the top 15 percent of the magnitude of each tag read based on the average RSSI value, maximum RSSI value and tag count. Each of these subsets corresponds to the central, intermediate and outer zones of read coverage as discussed in connection with field 502 of FIG. 5. Once the subsets are created, the process continues at step 822 where the data sets are arranged in a two-dimensional plane or representation according to the “best fit set” intersection. That is, an image such as that depicted in FIG. 6 is generated to graphically show the efficacy of the scans in terms of coverage and overlap. Finally, at step 824 the user is provided feedback based on created tag sets to identify accuracy or inaccuracy of the audit and the extent of set intersection. This user feedback can be displayed to the user as depicted in FIG. 7 in which a large percentage and small percentage of intersection or overlap can be shown. In one embodiment, this feedback serves as instructions to the mobile reader user to scan bar codes at a particular location in order to receive additional RFID tag data in areas where coverage from prior scans is less than optimal. The feedback can also include textual instructions directing the user to scan bar codes at a specified location. This information is presented to the user via the user interface of the mobile reader, which can include a display screen.

Through this collection of read data, a relative location of products scanned can be generated on a two-dimensional plane. This data can be used for post-audit analysis to provide a “heat-map” of missed products reads, similar to that shown in FIG. 3, or for use in other processes which require a product's relative location.

In another embodiment, a scan of a product UPC can be repeated multiple times while the antenna power level of the reader is increased. This adjustment generates more distinct data sets for analysis. This will provide better granularity concerning the actual location of the tags relative to the barcode scan. This adjustment during reads could impact the performance of the actual audit process. This adjustment practice, therefore, is better reserved as a supplemental or pre-processing process that can be performed prior to performing the subject audit. The generated data sets based on adjusted antenna power could then be used in the subject audit process as an additional waypoint directive in order to direct or correct an exact expected path for the user.

In an AIM system, RFID technology is utilized to sense tag movements within a coverage zone of a fixed RFID tag sensing device to ascertain product location and establish and maintain an inventory state. An AIM system includes one or more fixed devices equipped to read RFID tags located within the readable zone of the reader. The zone of the reader is typically in the fifty-meter range. Various items maintained by an enterprise can have RFID readable tags affixed thereon to track the location of the associated item. With tagged items that are tracked, it is common to lose visibility of tags for long periods of time. Tagged items can enter a location and not be sensed again for several months. A subsequent read of a tagged item that has not been sensed for a long period is necessary to obtain the correct status of the item, that is, whether the tag is still in a location.

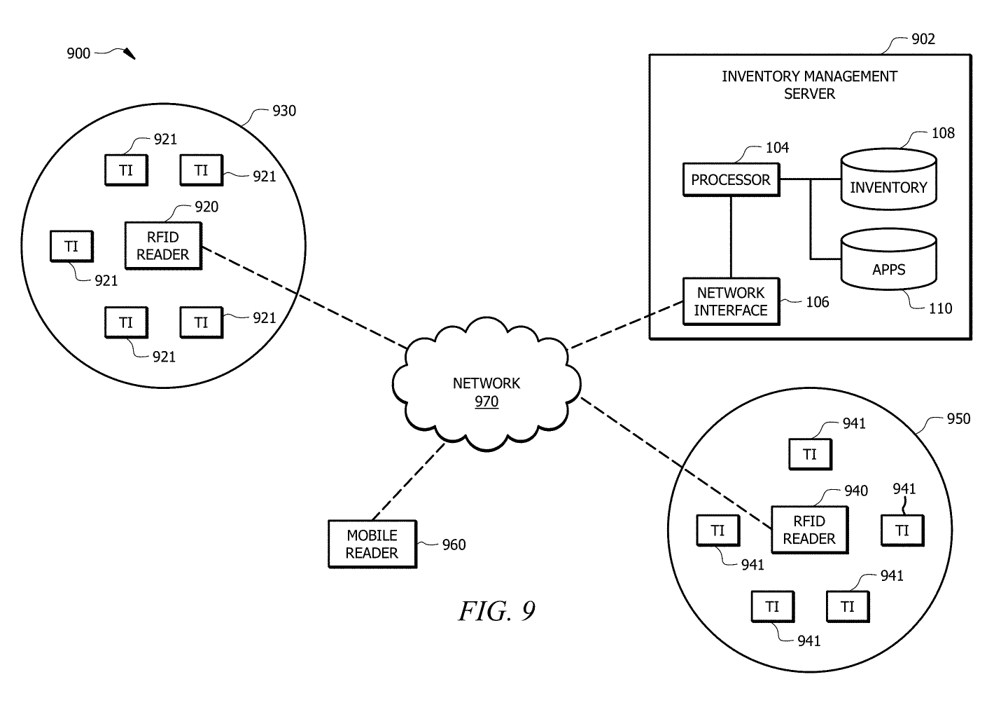

In one embodiment of an AIM system, as shown in FIG. 9, various RFID readers are fixed at optimal locations throughout an enterprise. In one scenario, the RFID readers are fixed at or near the ceiling of a large retail outlet or warehouse enabling reads of tagged items within a fifty-meter radius from the reader. In large enterprises, multiple readers are located strategically to provide coverage of all space within the enterprise. Readers having a fifty-meter coverage zone can be arranged linearly or in a honeycomb arrangement so as to provide adequate coverage of an entire facility.

The AIM system's ability to ascertain the status of an item is driven by the movement of that item within a reader's coverage zone. Assuming a tagged item is initially sensed and tracked as residing within a zone, the movement out of that zone will cause the system to change the status of that item to “sold” or “no longer within premises.” If there are multiple readers within an enterprise, however, and if that same item leaves a first zone and enters a second zone, the fixed RFID reader within the second zone should capture the presence of the item and designate the same item as within that second zone. Thus, the overall status of that item within the enterprise will remain as within the store or not sold.

Using a retail setting as an example, when a customer removes an item from the shelf for purchase, a properly functioning AIM system will track the item as it traverses each zone. Recalling that movement drives the status of an item, each zone that the tagged item enters and exits will result in the inventory within that zone being updated from “within zone” to “outside of zone”. If the customer purchases the item and leaves the store with it, that tagged item will find its home in no zone. Accordingly, the item will be designated as a sold item.

Problems arise, however, when an item is removed from the shelf and is re-shelved or placed in an area that is not sensed by the fixed RFID reader. In such instances, an item can be designated as “sold” when in fact it remains within the premises.

Using a mobile RFID reader can provide additional accuracy and supplement the data collected by the traditional AIM systems (i.e. to update the state of the tag). As a result, the AIM system can be more accurate and closer to delivering a “real-time” status of an item by utilizing a method for identifying tags that are still current as well as identifying tags that have exited.

AIM system output is used to direct a user to a desired audit locations of old last-seen tags via a mobile hand held RFID reader. For a mobile RFID audit, the known count of tags from the AIM solution is an indication of audit completion.

Input from AIM is used to guide a user with a mobile RFID reader to the claimed location of the tag (by AIM), then search for the tag. Information from the mobile RFID reader serves as feedback to the AIM system.

A weak point of AIM systems that leverage dynamic events is that tags can go into voids for long periods of time. This is not unusual. Using AIM as input, one can sort the tags by last-read timestamp to find the oldest tags. Then, using the mobile reader, a user can determine whether those tags are actually in the location that AIM claims. This will then be feedback to the AIM system to update the last-seen timestamp.

In one embodiment of the presently described AIM supplementation system, an RFID tag comes into a location and is visible to the AIM reader. If the AIM reader loses visibility of a tag because of tag detuning via metal shelving or otherwise, supplementation of AIM system status information is required. This can be achieved through analysis of the AIM system event stream output listing the tags that were visible, but now are not.

A method performed according to an embodiment of the present AIM supplementation system includes a tag search process in which all tag reads (both reads by the base AIM system and mobile RFID device reads) are sorted according to a last-read timestamp. Groupings of the tag reads are based on time distributions, creating a list of tags in the top five percent of the oldest tag reads. The timestamp data can indicate the item read and the reader (including the reader location) that last sensed the particular tag.

Once the location of a potentially stale time-stamped item is identified, the user of the mobile reader is directed to the general vicinity of the item of interest. This is typically within the overall zone of coverage of the relevant AIM fixed reader. Reads of tagged items with the mobile reader are obtained within approximately twenty feet from the mobile reader. As the mobile device senses the tags (which are unique to the associated item) the AIM system database is updated to reflect any new tags (tags seen by the mobile reader but not AIM). In the process, the timestamp for the particular item that was on the “stale read” list is updated to reflect the recent read by the mobile reader. Additionally, the status of the item is updated from “sold” or “no longer in stock”, etc. to “in stock”. In this manner, the mobile reader serves to refresh the AIM system inventory by eliminating errors caused by invalid assumptions made by the AIM system.

Mobile reader reads in other zones (other than items in a pre-determined list) serve a similar function as tag reads and corresponding timestamps of reads in any zone will be used to update AIM data. In addition, more sophisticated uses and methods concerning mobile RFID readers can be employed to automatically supplement AIM system data. In one embodiment of the present AIM supplementation system, data generated by the systems and methods described above for strategic RFID reading can be leveraged to update AIM system data. Note that for any items on the “stale item” AIM list, the mobile reader unit can still fail to identify a missing item. This can be the result of actual item shrinkage (i.e., the item was destroyed, stolen or purchased but not accounted for) or the result of an inadequate audit with the mobile reader due to operator error or inefficiency. In such cases, the methods described above for strategic RFID reading promote more sophisticated and accurate data gathering and inventorying of items with the mobile RFID device, including directing user bar code scans of a particular item essentially to force tag reads of items within the vicinity of that scanned item.

One embodiment in which the presently described supplemental automated inventory management system 900 can operate is described in FIG. 9. The system includes inventory management server 902 that includes a processor 104 and associated storage devices 108 and 110 on which inventory data is stored on storage device 108 and software applications for executing the processes described in the various embodiments herein can stored on storage device 110. Alternatively, software for carrying out some or all of the processes and methods of the various embodiments of the presently described AIM supplementation system may reside in storage of mobile reader 960. Such application programs include instructions readable by processor 104 to execute the various functions of supplemental inventory management system 900 according to the methods described herein. Inventory management server also includes a network interface 106 through which server 902 can communicate with other system devices through a variety of network protocols. Storage device 108 on which inventory data is stored can include Known Touchpoints (KT), barcode location data and identification data. Server 902 is in communication with one or more stationary RFID readers 920 and 940 over a network 970. Network 970 can facilitate communications among compatible devices and can receive and transmit data according to various protocols, including a WLAN protocol (802.11), Internet protocol, or other known wireless and wired protocols.

Each stationary RFID reader 920 and 940 has an associated zone of coverage 930 and 950, respectively. The zone of coverage is an area in which items bearing RFID tags will be read by the reader. Typically, RFID readers 920 and 940 will have a range of fifty meters. That is, any item bearing an RFID tag within a fifty-meter radius of reader 920 or 940 will be sensed by that reader. RFID readers 920 and 940 are often affixed to the ceiling of an enterprise to promote ceiling to floor coverage of items bearing RFID tags. Various tagged items 921 and 941 residing within a zone of coverage of the RFID reader will be sensed by that reader. Storage device 108 including inventory data can also include resulting inventories received from one or more mobile readers 960. Storage device 106 can include application programs delivered to a particular mobile reader 960 according to a location at which a user of that mobile reader is taking inventory.

As previously described, mobile devices 960 can offer a range of functionality. In one embodiment, mobile device 960 can include components that allow the device to read a UPC barcode and an RFID tag. With a device such as this, the user can simultaneously achieve very broad, accurate and strategic coverage of reading RFID tags through scanning of selective UPC barcodes located on the article to be inventoried. As a result, a comprehensive, accurate, location-oriented RFID reading operation is performed by a mobile RFID reader 960 operated by even a minimally skilled or trained human. One or several intermediary devices between RFID readers 920 and 940 and inventory management server 902 can be in place to facilitate communication between the endpoint devices.

RFID readers 920 and 940 can periodically sweep their respective coverage zones for tagged items and will continuously monitor and sense items that move into their associated coverage zone. Once a baseline of inventoried tagged items is established and stored within storage device 108, the method of the present invention to supplement the findings of RFID readers 920 and 940 can be invoked.

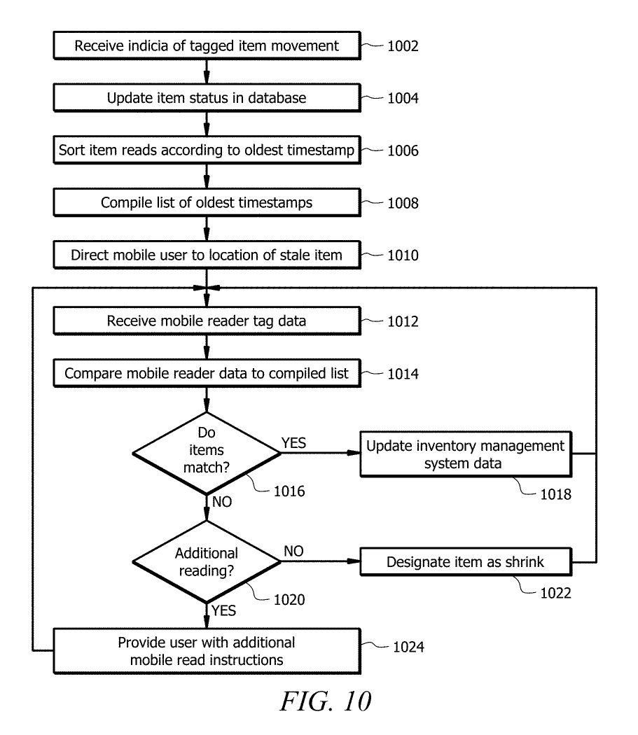

FIG. 10 is an embodiment of a method of supplementing automated inventory management system data. The method described with reference to FIG. 10 can be performed by inventory management (IM) server 902 through execution of machine readable instructions stored on storage device 110. In FIG. 10, it is assumed that stored within storage device 108 is previously collected inventory data reflecting tagged items sensed by various stationary RFID readers situated throughout an enterprise, indicating the presence of tagged items within at least one coverage zone. With subsequent item movement from one zone to another, the method begins at step 1002 where server IM server 902 receives indicia of tagged item movement within a coverage zone of an RFID reader. This means an item has been placed within a zone for the first time or an item has left one zone and entered another. Next, at step 1004, the status of the item, which is uniquely identified by an RFID tag, is updated in inventory database 108. At step 1006, periodically collected data for tagged items within inventory database 108 is sorted according to the age of the timestamp when each item was sensed by an RFID reader. The timestamp will be a clock value or other numeric value that is incremented automatically in a manner that results in older RFID readings of an item bearing a lower value. Next, at step 1008 a list is compiled of the oldest timestamps within inventory storage 108. In one embodiment, the top five percent of item reads according to age is compiled but any limit can be set as a threshold according to particular use-case needs.

This compilation will include the identifier of the RFID tag associated with an item, the calculated location of the item, and the timestamp of the last recording of the item's RFID read. The compiled list at step 1008, therefore, will reflect not only the oldest or stalest item reads but also the RFID reader that last sensed that item. With this list compiled, the method continues at step 1010 where a mobile reader user is directed to the location of a listed item. The user of mobile reader 960 will be directed to make manual scans in the vicinity of the relevant stationary RFID reader and can be directed to scan a particular item at a particular location believed to be in close proximity to the item in question. The mobile reader having a range of approximately twenty feet and that is capable of reading shelved items is expected to sense RFID tags of all items within mobile reader range.

Once the mobile reader user scans the tagged items as directed, the data collected by the mobile reader 960 is received by IM server 902 at step 1012 and at step 1014 the newly collected mobile reader data is compared to the compiled list. At step 1016, the system queries whether any items on the compiled list match the newly received data from mobile reader 960. If the answer is “yes” this means that the questionable item bearing on old timestamp has been located and in fact, has not left the premises but remains in inventory. Accordingly, at step 1018 the IM system's inventory data stored in device 108 is updated to reflect the item's status. This update will include an update of the timestamp associated with a tagged item. That is, the time that the item was recently recognized by mobile device 960 will be refreshed, meaning that this item will not be compiled at step 1008 in future operations for some time. Alternatively, if at step 1016 there is no match between items received from mobile reader 960 and the compiled list, the process continues to step 1020 where the system queries whether additional mobile reader 960 readings are required. If the answer to this question is “yes” then at step 1024 the mobile reader user is provided with additional scanning instructions, such as directing the mobile reader user to a different location or to scan the barcode or RFID tag of a specific item. The process repeats starting at step 1012 with receipt of the mobile reader data and continues. If, on the other hand, no additional reads are required and the answer at query 1020 is “no”, then the method proceeds to step 1022 and the item(s) on the compiled list are designated as “shrink” or otherwise shown as no longer in inventory.

Through this process, data collected by RFID readers 920 and 940 are continuously supplemented and refreshed by mobile readers to increase the veracity of the AIM inventory by including items inventoried but not readily visible by AIM system readers.

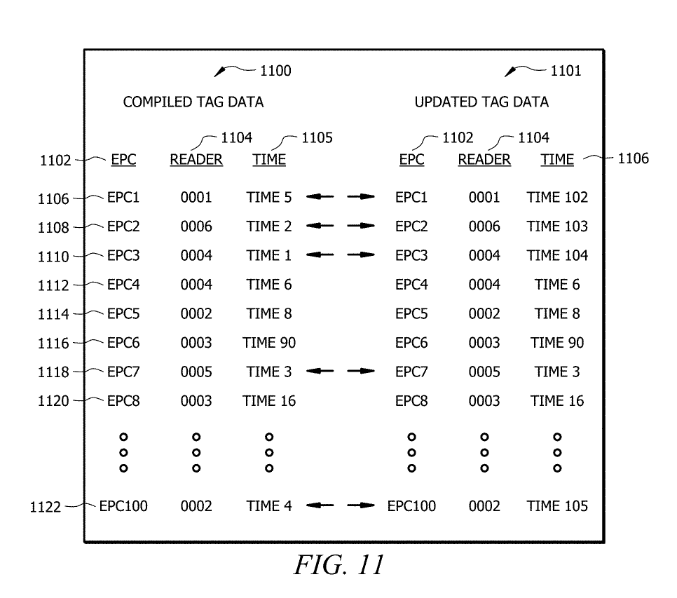

An embodiment of stored data in inventory storage device 108 is depicted in FIG. 11. FIG. 11 depicts compiled tag data list 1100 collected as described with respect to the method of FIG. 10 and updated tag data list 1101 once the methods of the present invention, such as that described in FIG. 10, are performed. In compiled tag data list 1100 a series of EPC numbers representing the unique RFID tag numbers associated with various items are shown as 1106, 1108, 1110, 1112, 1114, 1116, 1118, 1120 and 1122. The same item identifiers are provided in updated tag data list 1101. Lists 1100 and 1101 include RFID reader identifiers 1104 that provides users with an indicator of which reader within the enterprise sensed the particular item RFID tag. Also included in compiled data list 1100 is timestamp column 1105. Column 1106 includes the time at which the particular item on the list was last detected by a stationary RFID reader. The lower the value within column 1105, the older the data associated with the item.

In connection with the list compilation process described with respect to FIG. 10, only the items in inventory bearing the oldest time stamps will be used for analysis according to thresholds set by the system administrator. In list 1100, tagged items 1106, 1108, 1110, 1118 and 1122 are highlighted or selected for analysis as these items are the oldest items in inventory in terms of last item movement. Those items have timestamps values of 5, 2, 1, 3 and 4, which are the five oldest of the one hundred items on list 1100.

Following execution of the methods described in FIG. 10 and in particular receipt of mobile reader 960 data following directed mobile reader scans, information associated with the highlighted items in compiled list 1100 is updated as shown on updated tag data list 1101. In updated tag data list 1101, timestamp column 1106 has been updated to reflect those highlighted items on compiled tag data list 1100 that were sensed by mobile reader 960 and those that were not. Specifically, the timestamp value for items 1106, 1108, 1110 and 1122 have been updated to reflect timestamp values of “102”, “103”, “104” and “105”, respectively. This means that those items were recently sensed by mobile reader 960 and the recent timestamp value reflects that. Item 1118, on the other hand, was not sensed by mobile reader 960 as its timestamp value remains at “3”. As a result, the status of items 1106, 1108, 1110 and 1122 within inventory database 908 is updated as remaining in inventory. Item 1118 can be designated as item shrink or further analysis of that inventory item can be performed.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious variants thereof is contemplated as falling within the spirit and scope of the disclosed inventions.

While the invention has been particularly shown and described with reference to a preferred embodiment, it will be understood by those skilled in the art that various changes in form and detail can be made therein without departing from the spirit and scope of the invention.

### ADDITIONAL DESCRIPTION

The following clauses are offered as further description of the disclosed invention.
Clause 1. A system for directing the collection of inventory data, comprising:

a mobile radio frequency identification (RFID) tag reader, comprising:
a scanner for reading an identifier associated with an item;
an antenna for receiving a plurality of unique RFID identifiers associated with inventory items; and
a user interface comprising a display for communicating an inventory process instruction to a user;

a memory and processor configured to perform the steps of:
generating a first data set comprising a time stamp value and a signal strength value for each of the plurality of unique RFID identifiers received by the mobile RFID tag reader;
updating the first data set with a count data associated with the frequency of receipt by the mobile RFID tag reader of each of the plurality of unique RFID identifiers, an average signal strength value and a maximum signal strength value associated with each of the plurality of received unique RFID identifiers;
ranking each of the plurality of the received unique identifiers according to the count data, the average signal strength value and maximum signal strength value; and
transmitting to the mobile RFID tag reader an instruction according to the ranking to scan an identifier associated with an item at a specified location.
Clause 2. The system for directing the collection of inventory data of any proceeding or preceding clause, further comprising the memory and processor configured to perform the step of grouping each of the plurality of the received unique identifiers according to a comparison of the time stamp value in relation to a time value of a scanned product identifier of an item.
Clause 3. The system for directing the collection of inventory data of any proceeding or preceding clause, wherein the ranking further comprises creating subsets of the plurality of received unique identifiers according to a magnitude value assigned to each of the plurality of received unique identifiers according to the count data, the average signal strength value and maximum signal strength value.
Clause 4. The system for directing the collection of inventory data of any proceeding or preceding clause, further comprising the memory and processor configured to perform the step of generating a graphical representation of the plurality of received unique identifiers associated with at least one scanned product identifier of an item.
Clause 5. The system for directing the collection of inventory data of any proceeding or preceding clause, wherein the graphical representation depicts a coverage area of the mobile RFID tag reader of received unique identifiers according to a location of at least one scanned product identifier of an item.
Clause 6. The system for directing the collection of inventory data of any proceeding or preceding clause, wherein the instruction transmitted to the user further comprises the graphical representation.
Clause 7. A method of directing the collection of inventory data, comprising:
   scanning with a mobile radio frequency identification (RFID) tag reader an identifier associated with a first item;
   receiving, through an antenna of the mobile RFID tag reader, a plurality of unique RFID identifiers associated with inventory items located within a coverage area of the first scanned item;
   generating a first data set comprising a time stamp value, a count data associated with the frequency of receipt by the mobile RFID tag reader of each of the plurality of unique RFID identifiers, an average signal strength value and a maximum signal strength value associated with each of the plurality of received unique RFID identifiers received following the scan of the identifier of the first item;
   ranking each of the plurality of the received unique identifiers according to the count data, the average signal strength value and maximum signal strength value; and
   transmitting, according to the ranking, an instruction to the mobile RFID tag reader to scan an identifier associated with a second item.
Clause 8. The method of directing the collection of inventory data of any proceeding or preceding clause, wherein the ranking step further comprises creating subsets of the plurality of received unique identifiers according to a magnitude value assigned to each of the plurality of received unique identifiers according to the count data, the average signal strength value and maximum signal strength value.
Clause 9. The method of directing the collection of inventory data of any proceeding or preceding clause, further comprising the step of grouping each of the plurality of the received unique identifiers according to grouping each of the plurality of the received unique identifiers according to a comparison of the time stamp value to a time value of a scanned product identifier of an item.
Clause 10. The method of directing the collection of inventory data of any proceeding or preceding clause, further comprising generating a graphical representation of received unique identifiers associated with the scanned product identifier of the first item.
Clause 11. The method of directing the collection of inventory data of any proceeding or preceding clause, wherein the graphical representation depicts a coverage area of the mobile RFID tag reader of the plurality of received unique identifiers according to a location of the scanned product identifier of the first item.
Clause 12. The method of directing the collection of inventory data of any proceeding or preceding clause, wherein the transmitted instruction comprises the graphical representation displayed on a user interface of the mobile RFID tag reader.
Clause 13. The method of directing the collection of inventory data of any proceeding or preceding clause, further comprising
   scanning the identifier associated with the second item; and
   updating the first data set with a time stamp value, count data associated with the frequency of receipt by the mobile RFID tag reader of each of a plurality of unique RFID identifiers, an average signal strength value and a maximum signal strength value associated with each of the plurality of received unique RFID identifiers associated with inventory items located within a coverage zone of the second scanned item.
Clause 14. An apparatus for providing real time instructions for the collection of inventory data, comprising:

a mobile radio frequency identification (RFID) tag reader, comprising:
a scanner for reading an item identifier; and
an antenna for receiving a plurality of unique RFID identifiers associated with inventory items; and
a memory and a processor configured to perform the steps of:
   generating a first data set comprising a time stamp value and a signal strength value for each of the plurality of unique RFID identifiers received by the mobile RFID tag reader;
   updating the first data set according to a parameter of each of the plurality of received unique RFID identifiers;
   ranking each of the plurality of the received unique identifiers according to the updated first data set; and
   transmitting to the mobile RFID tag reader an instruction according to the ranking to scan an identifier associated with an item at a specified location.
Clause 15. The apparatus for providing real time instructions for the collection of inventory data of any proceeding or preceding clause, wherein the parameter comprises a count data associated with the frequency of receipt by the mobile RFID tag reader of each of the plurality of unique RFID identifiers and an average signal strength value and a maximum signal strength value associated with each of the plurality of received unique RFID identifiers
Clause 16. The apparatus for providing real time instructions for the collection of inventory data of any proceeding or preceding clause, further comprising the memory and processor configured to perform the step of grouping each of the plurality of the received unique identifiers according to a comparison of the time stamp value to a time value of a scanned product identifier of an item.
Clause 17. The apparatus for providing real time instructions for the collection of inventory data of any proceeding or preceding clause, wherein the ranking further comprises creating subsets of the plurality of received unique identifiers according to a magnitude value assigned to each of the plurality of received unique identifiers according to the count data, the average signal strength value and maximum signal strength value.
Clause 18. The apparatus for providing real time instructions for the collection of inventory data of any proceeding or preceding clause, further comprising the memory and processor configured to perform the step of generating a graphical representation of the plurality of received unique identifiers associated with at least one scanned product identifier of an item.
Clause 19. The apparatus for providing real time instructions for the collection of inventory data of any proceeding or preceding clause, wherein the graphical representation depicts coverage by the mobile RFID tag reader of received unique identifiers according to a location of the at least one scanned product identifier of the item.
Clause 20. The apparatus for providing real time instructions for the collection of inventory data of any proceeding or preceding clause, wherein the instruction transmitted to the user further comprises the graphical representation.
Clause 21. The apparatus for providing real time instructions for the collection of inventory data of any preceding clause, further comprising a user interface comprising a display for communicating an inventory process instruction to a user.

What is claimed is:

1. A system for directing the collection of inventory data, comprising:
a mobile radio frequency identification (RFID) tag reader, comprising:
a scanner for reading an identifier associated with an item;
an antenna for receiving a plurality of unique RFID identifiers associated with inventory items; and
a user interface comprising a display for communicating an inventory process instruction to a user;
a memory and processor configured to perform the steps of:
generating a first data set comprising a time stamp value and a signal strength value for each of the plurality of unique RFID identifiers received by the mobile RFID tag reader;
updating the first data set with a count data associated with the frequency of receipt by the mobile RFID tag reader of each of the plurality of unique RFID identifiers, an average signal strength value and a maximum signal strength value associated with each of the plurality of received unique RFID identifiers;
ranking each of the plurality of the received unique identifiers according to the count data, the average signal strength value and maximum signal strength value; and
transmitting to the mobile RFID tag reader an instruction according to the ranking to scan an identifier associated with an item at a specified location.

2. The system of claim 1, further comprising the memory and processor configured to perform the step of grouping each of the plurality of the received unique identifiers according to a comparison of the time stamp value in relation to a time value of a scanned product identifier of an item.

3. The system of claim 1, wherein the ranking further comprises creating subsets of the plurality of received unique identifiers according to a magnitude value assigned to each of the plurality of received unique identifiers according to the count data, the average signal strength value and maximum signal strength value.

4. The system of claim 1, further comprising the memory and processor configured to perform the step of generating a graphical representation of the plurality of received unique identifiers associated with at least one scanned product identifier of an item.

5. The system of claim 4, wherein the graphical representation depicts a coverage area of the mobile RFID tag reader of received unique identifiers according to a location of at least one scanned product identifier of an item.

6. The system of claim 5, wherein the instruction transmitted to the user further comprises the graphical representation.

7. A method of directing the collection of inventory data, comprising:
scanning with a mobile radio frequency identification (RFID) tag reader an identifier associated with a first item;
receiving, through an antenna of the mobile RFID tag reader, a plurality of unique RFID identifiers associated with inventory items located within a coverage area of the first scanned item;
generating a first data set comprising a time stamp value, a count data associated with the frequency of receipt by the mobile RFID tag reader of each of the plurality of unique RFID identifiers, an average signal strength value and a maximum signal strength value associated with each of the plurality of received unique RFID identifiers received following the scan of the identifier of the first item;
ranking each of the plurality of the received unique identifiers according to the count data, the average signal strength value and maximum signal strength value; and
transmitting, according to the ranking, an instruction to the mobile RFID tag reader to scan an identifier associated with a second item.

8. The method of claim 7, wherein the ranking step further comprises creating subsets of the plurality of received unique identifiers according to a magnitude value assigned to each of the plurality of received unique identifiers according to the count data, the average signal strength value and maximum signal strength value.

9. The method of claim 7, further comprising the step of grouping each of the plurality of the received unique identifiers according to grouping each of the plurality of the received unique identifiers according to a comparison of the time stamp value to a time value of a scanned product identifier of an item.

10. The method of claim 7, further comprising generating a graphical representation of received unique identifiers associated with the scanned product identifier of the first item.

11. The method of claim 10, wherein the graphical representation depicts a coverage area of the mobile RFID tag reader of the plurality of received unique identifiers according to a location of the scanned product identifier of the first item.

12. The method of claim 10, wherein the transmitted instruction comprises the graphical representation displayed on a user interface of the mobile RFID tag reader.

13. The method of claim 7, further comprising
scanning the identifier associated with the second item; and
updating the first data set with a time stamp value, count data associated with the frequency of receipt by the mobile RFID tag reader of each of a plurality of unique RFID identifiers, an average signal strength value and a maximum signal strength value associated with each of the plurality of received unique RFID identifiers associated with inventory items located within a coverage zone of the second scanned item.

14. An apparatus for providing real time instructions for the collection of inventory data, comprising:
a mobile radio frequency identification (RFID) tag reader, comprising:
a scanner for reading an item identifier; and
an antenna for receiving a plurality of unique RFID identifiers associated with inventory items; and
a memory and a processor configured to perform the steps of:
generating a first data set comprising a time stamp value and a signal strength value for each of the plurality of unique RFID identifiers received by the mobile RFID tag reader;
updating the first data set according to a parameter of each of the plurality of received unique RFID identifiers;
ranking each of the plurality of the received unique identifiers according to the updated first data set; and
transmitting to the mobile RFID tag reader an instruction according to the ranking to scan an identifier associated with an item at a specified location.

15. The apparatus of claim 14, wherein the parameter comprises a count data associated with the frequency of receipt by the mobile RFID tag reader of each of the plurality of unique RFID identifiers and an average signal strength value and a maximum signal strength value associated with each of the plurality of received unique RFID identifiers.

16. The apparatus of claim 14, further comprising the memory and processor configured to perform the step of grouping each of the plurality of the received unique identifiers according to a comparison of the time stamp value to a time value of a scanned product identifier of an item.

17. The apparatus of claim 14, wherein the ranking further comprises creating subsets of the plurality of received unique identifiers according to a magnitude value assigned to each of the plurality of received unique identifiers according to the count data, the average signal strength value and maximum signal strength value.

18. The apparatus of claim 14, further comprising the memory and processor configured to perform the step of generating a graphical representation of the plurality of received unique identifiers associated with at least one scanned product identifier of an item.

19. The apparatus of claim 18, wherein the graphical representation depicts coverage by the mobile RFID tag reader of received unique identifiers according to a location of the at least one scanned product identifier of the item.

20. The apparatus of claim 19, wherein the instruction transmitted to the user further comprises the graphical representation.

21. The apparatus of claim 14, further comprising a user interface comprising a display for communicating an inventory process instruction to a user.
